(19) United States
(12) Patent Application Publication
(10) Pub. No.: US 2003/0025258 A1
(43) Pub. Date: Feb. 6, 2003

(54) Grooved or ribbed bushing and mating grooved or ribbed bushing receiving bore included within a suspension component

(76) Inventors: Brent R. Collyer, Wellesley (CA); Daniel R. Adema, Waterloo (CA)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 09/921,359

(22) Filed: Aug. 2, 2001

(51) Int. Cl. F16F 1/30

(52) U.S. Cl. 267/269; 280/124.175

(57) ABSTRACT

A suspension component connection assembly in the form of a leaf spring connection assembly is shown to include a leaf spring having a leaf spring eye with a grooved portion positioned intermediate its axial ends. A sleeveless bushing is installed within the leaf spring eye and includes a ribbed portion designed to fit within the grooved portion. Centering and retention consistency is achieved thereby.

### BACKGROUND OF THE INVENTION

The present invention relates generally to vehicle suspension system components and more particularly to new components used in association with vehicle suspension systems that provide increased bushing retention.

Leaf springs are components used in a variety of vehicle suspension systems. As an example, leaf springs are used on most heavy-duty truck suspensions as a component thereof. Leaf springs are used to support the load of the vehicle, react braking and acceleration, react cornering forces, isolate the vehicle from the road, provide roll stiffness, align the vehicle axle, and maintain vehicle axle caster. Leaf springs are typically connected at opposite ends of the conventional C-shaped frame rail extending longitudinally on one side of the vehicle. Typically, a similar spring is incorporated for connection with the C-shaped frame rail positioned on the opposite side of the vehicle. The leaf springs are connected to the rails through frame hangers at pivot points that control the articulation of the suspension.

Leaf springs are ordinarily connected to the frame rails at their opposing ends by way of a formed eye of the leaf spring that accepts a bushing adapted to permit such connection. The bushing components typically utilize pin type connections in double shear type hangers and shackles. Traditionally, leaf spring bushings include an elastomeric core that is confined by an outer metal sleeve. Such bushings conventionally have three layers, including an inter metal sleeve (or pin), the elastomeric core and the outer metal sleeve. The bushings are typically installed or assembled into each leaf spring eye located at opposite ends of the leaf spring to permit connection with the frame hangers and/or shackles.

Use of traditional bushings having an outer metal sleeve to connect the leaf springs to the frame hangers has at least three notable drawbacks. First, the cost associated with manufacture and assembly of the bushing increases when it includes two metal portions. Second, bushings having an outer metal sleeve are typically relatively heavy, which translates into reduced payload capacity for commercial vehicles. Third, bushings having an outer metal sleeve typically do not fit as well within the eye of the leaf spring in that the generally perfectly round outer metal “rocks” within the inconsistent inner diameter of the leaf spring eye. As will be appreciated by those skilled in the art, this inconsistent inner diameter can be the result of manufacturing tolerances. In an extreme case, the rocking action of the bushing during leaf spring deflection resulting from suspension system articulation can cause the bushing to walk out of the leaf spring eye, creating hazardous conditions, and causing the spring to wear on the hanger or shackle.

The drawbacks associated with use of traditional bushings having an outer metal sleeve have led to the development of sleeveless bushings. Sleeveless bushings, by definition, eliminate the outer metal sleeve and thereby reduce the cost associated with the manufacture and assembly of the bushings. Further, sleeveless bushings are generally lighter in weight, translating into increased payload capacity. Third, sleeveless bushings provide for a more consistent fit within the leaf spring eye as they are permitted to flow within the eye to achieve the desired confinement required for adequate fatigue resistance.

A spool type rubber sleeveless bushing is currently the least expensive and maintenance free bushing option available for leaf spring eyes. While such bushings are the best available, it has been found that adequate bushing retention and centering consistency are difficult to achieve with such bushings when used in conjunction with conventional leaf spring eyes. Current spool bushing designs tend to have outer lips at either or both ends of the spool bushing that help improve retention loads. However, the elastomeric portion of these bushings tends to extend axially beyond the ends of the leaf spring eye and make installation into hangers and shackles difficult.

In view of the foregoing, it is desirable to develop a new and improved bushing.

It is further desirable to develop a new leaf spring eye construction.

It is further desirable to develop a new construction for a bushing receiving bore included as a portion of a vehicle suspension component.

It is further desirable to develop a sleeveless bushing that replaces traditional bushings having an outer metal sleeve, thereby reducing the cost associated with a suspension system that uses the bushing.

It is further desirable to develop suspension system components that reduce the total weight of the suspension system in which they are used, thereby translating into greater payload capacity for commercial vehicles using that suspension system.

It is further desirable to develop suspension system components that provide for an effective method of manufacture.

It is further desirable to develop suspension system components having an increased field life.

It is further desirable to develop a bushing and suspension system component, where the bushing may be installed in the suspension system component to maintain adequate centering of the width of that component to ensure the component is nominally centered in a hanger or shackle attached to a vehicle frame rail.

It is further desirable to develop a bushing and suspension system component, where the bushing will more likely be retained within a bushing receiving bore of the suspension system component.

These and other objects of the preferred forms of the invention will become apparent from the following description. It will be understood, however, that an apparatus could still appropriate the invention claimed herein without accomplishing each and every one of these objects, including those gleaned from the following description. The appended claims, not the objects, define the subject matter of this invention. Any and all objects are derived from the preferred forms of the invention, not necessarily the invention in general.

### BRIEF SUMMARY OF THE INVENTION

The present invention is directed to a suspension component connection assembly. The suspension component connection assembly includes a suspension component having a bushing receiving bore with first and second opposing axial ends. The bushing receiving bore includes a groove portion positioned intermediate the first and second axial ends of the suspension component. The suspension component connection assembly further includes a sleeveless bushing having an elastomeric portion with first and second opposing axial ends. The elastomeric portion has a ribbed portion positioned intermediate its first and second axial ends. The ribbed portion is adapted to fit within the groove portion of the suspension component.

The present invention is also directed to an alternative embodiment of a suspension component connection assembly. The suspension component connection assembly includes a suspension component having a bushing receiving bore with first and second opposing axial ends. The bushing receiving bore includes a ribbed portion positioned intermediate the first and second axial ends of the suspension component. The suspension component connection assembly further includes a sleeveless bushing having an elastomeric portion with first and second opposing axial ends. The elastomeric portion has a grooved portion positioned intermediate its first and second axial ends. The ribbed portion of the bushing receiving bore is adapted to fit within the groove portion of said bushing.

The present invention is also directed to still another embodiment of a suspension component connection assembly. The suspension component connection assembly includes a suspension component having a bushing receiving bore with first and second opposing axial ends. The bushing receiving bore includes a slot portion positioned intermediate the first and second axial ends of the suspension component. The suspension component connection assembly further includes a sleeveless bushing having an elastomeric portion with first and second opposing axial ends. The elastomeric portion has a protrusion positioned intermediate its first and second axial ends. The protrusion is adapted to fit within the slot of the suspension component.

In a preferred embodiment, the suspension component comprises a leaf spring and the bushing receiving bore comprises a leaf spring eye. In another preferred embodiment, the suspension component comprises a shackle assembly.

In a preferred embodiment, the bushing receiving bore has an inner diameter with a circumferential length and the groove portion of the suspension component extends substantially along the circumferential length of the inner diameter in its entirety. In another preferred embodiment, the bushing receiving bore has an inner diameter with a circumferential length and the groove portion of the suspension component extends along only a portion of the circumferential length of the inner diameter.

### BRIEF DESCRIPTION OF THE SEVERAL VIEWS OF THE DRAWING

In the detailed description, reference will frequently be made to the following figures of the drawing, in which like reference numerals refer to like components and portions thereof, and in which:

FIG. 1 is a side elevational view of a suspension system that can incorporate subject matter constructed in accordance with the principles of the present invention;

FIG. 2 is an isometric view of material that is used to form a leaf spring eye constructed in accordance with the principles of the present invention;

FIG. 3 is an exploded isometric view of suspension system components constructed in accordance with the principles of the present invention;

FIG. 4 is a sectional view of the components shown in FIG. 3, as installed, taken along line 4-4 thereof;

FIG. 5 is an isometric view of an alternative embodiment of material used to form a leaf spring eye constructed in accordance with the principles of the present invention;

FIG. 6 is an exploded isometric view of an alternative group of components constructed in accordance with the principles of the present invention;

FIG. 7 is a sectional view of the component shown in FIG. 6, as installed, taken along line 7-7 thereof;

FIG. 8 is an isometric view of an alternative standard bushing component;

FIG. 9 is an isometric view of an alternative embodiment of a leaf spring eye constructed in accordance with the principles of the present invention;

FIG. 10 is an isometric view of another alternative embodiment of a leaf spring eye constructed in accordance with the principles of the present invention;

FIG. 11 is an isometric view of another alternative embodiment of a leaf spring eye constructed in accordance with the principles of the present invention;

FIG. 12 is a side elevational view of a suspension system that can incorporate components constructed in accordance with the principles of the present invention;

FIG. 13A is a sectional view taken along lines 13-13 of FIG. 12, depicting components constructed in accordance with the principles of the present invention; and

FIG. 13B is a sectional view taken along lines 13-13 of FIG. 12, similar to FIG. 13A, but depicting alternative embodiments of components constructed in accordance with the principles of the present invention.

### DETAILED DESCRIPTION OF THE INVENTION

FIG. 1 illustrates conventional components included within vehicles, such as commercial vehicles, including a C-shaped longitudinally extending frame rail 20, a laterally extending axle 22, and suspension system components generally designated by reference numeral 24. A frame hanger 26 is attached to frame rail 20 to permit connection with a leaf spring assembly 28. Leaf spring assembly 28 includes a leaf spring eye 30 that receives a bushing 32 to permit connection with frame hanger 26. Leaf spring eye 30 and bushing 32 are constructed in accordance with the principles of the present invention, as described below.

Axle 22 and leaf spring assembly 28 are connected together by axle clamp assembly components generally designated 34. An air spring 36 is further included and is attached at its upper side to an air spring bracket 38 mounted to frame rail 20. At its lower side, air spring 36 is seated on a distal end portion of leaf spring assembly 28. In this illustrated example, leaf spring assembly 28 has a z-shape configuration, which is generally known by those skilled in the art.

It will be apparent to those skilled in the art that while a particular suspension system is illustrated in FIG. 1, the principles of the present invention apply to a wide variety of suspension systems that use bushings. It will also be appreciated that a variety of suspension components can be used, provided such components use bushings for connection to other components and therefore have one or more bushing receiving bores as portions thereof to permit installation of bushings.

FIG. 2 illustrates material 40 used to form a leaf spring. The portion of material 40 illustrated in FIG. 2 corresponds to that portion used to form the leaf spring eye of a conventional leaf spring. In leaf springs, the eye typically serves as a bushing receiving bore for the suspension component. The inside surface defining the outer extent and boundary of the inner diameter for the leaf spring is illustrated as the top surface of material 40 in FIG. 2. In accordance with the principles of the present invention, a groove 42 is forged on that inside surface of the leaf spring eye and extends substantially along the entire circumference of the inner diameter for the leaf spring eye. Groove 42 is positioned at a location intermediate the axial ends of the leaf spring eye, which ends are defined by the side surfaces of material 40. Throughout this description, a single groove and/or ribbed portion is shown for each suspension component and/or bushing. It will be appreciated by those skilled in the art that multiple grooves and/or ribbed portions can be embodied in any such suspension component and/or bushing, in any available combination thereof, in order to carry out the principles of the present invention.

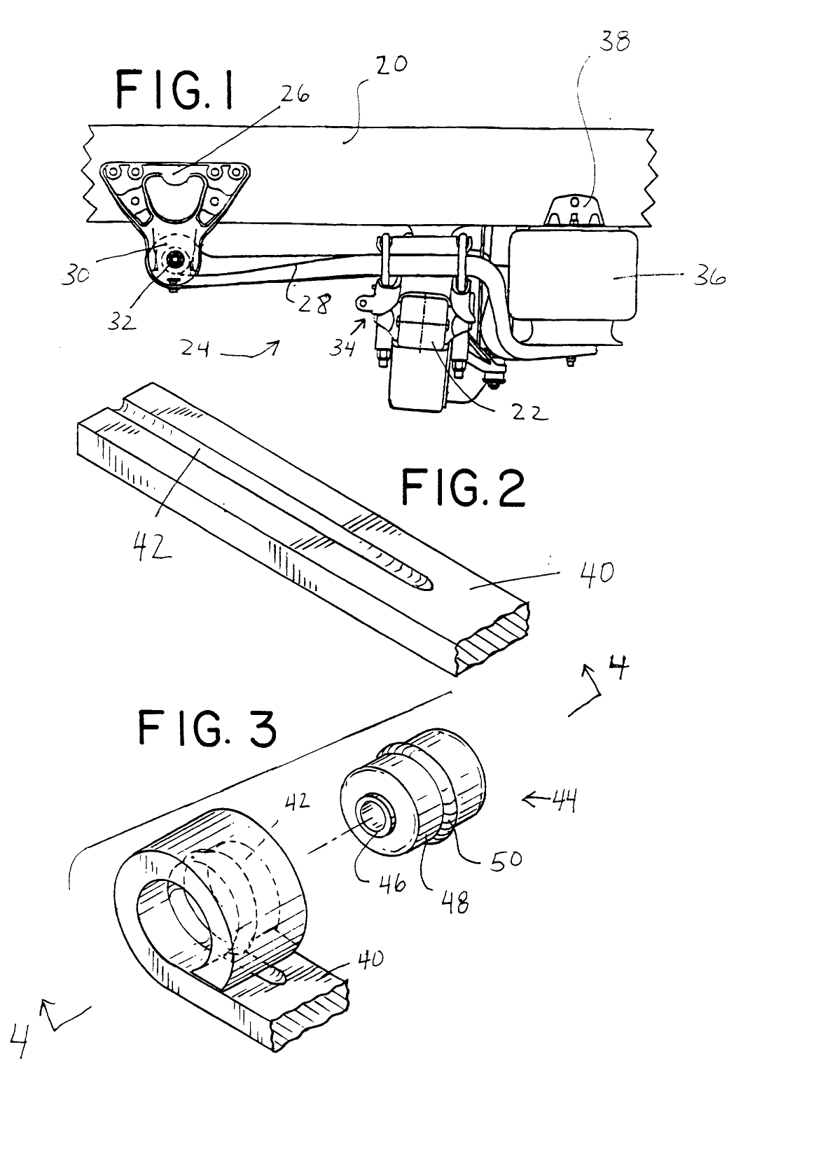

FIG. 3 illustrates a suspension component connection assembly shown in the form of the leaf spring eye formed by the portion of material 40 illustrated in FIG. 2. As shown, groove 42 extends substantially along the entire circumference of the inner diameter of the leaf spring eye. As further shown, groove 42 is positioned at a location intermediate the axial ends of the leaf spring eye.

FIG. 3. also illustrates a sleeveless bushing 44 constructed in accordance with the principles of the present invention. Sleeveless bushing 44 includes an inner metal sleeve 46 and an elastomeric portion 48 surrounding and adhered to the inner metal sleeve in any manner well known in the art. As shown, and in accordance with the principles of the present invention, elastomeric portion 48 includes a ribbed portion 50 extending radially outward and circumferentially about the elastomeric portion at a position located intermediate its axial ends.

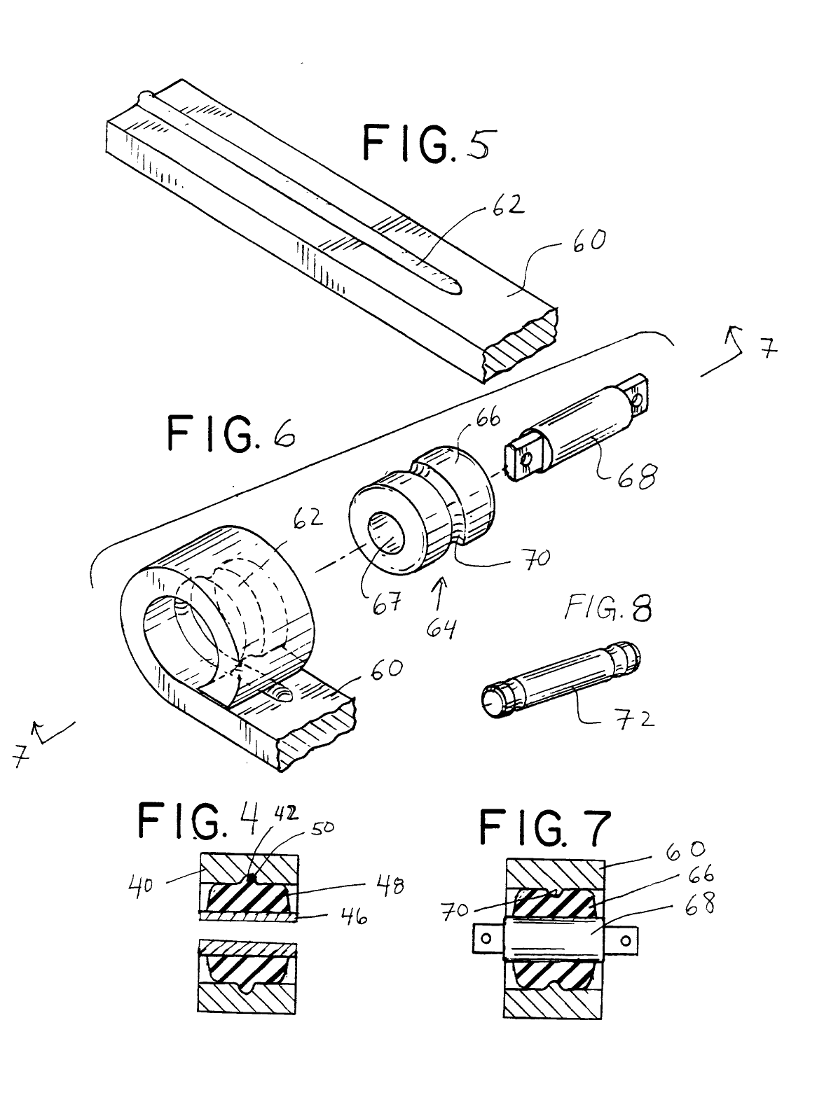

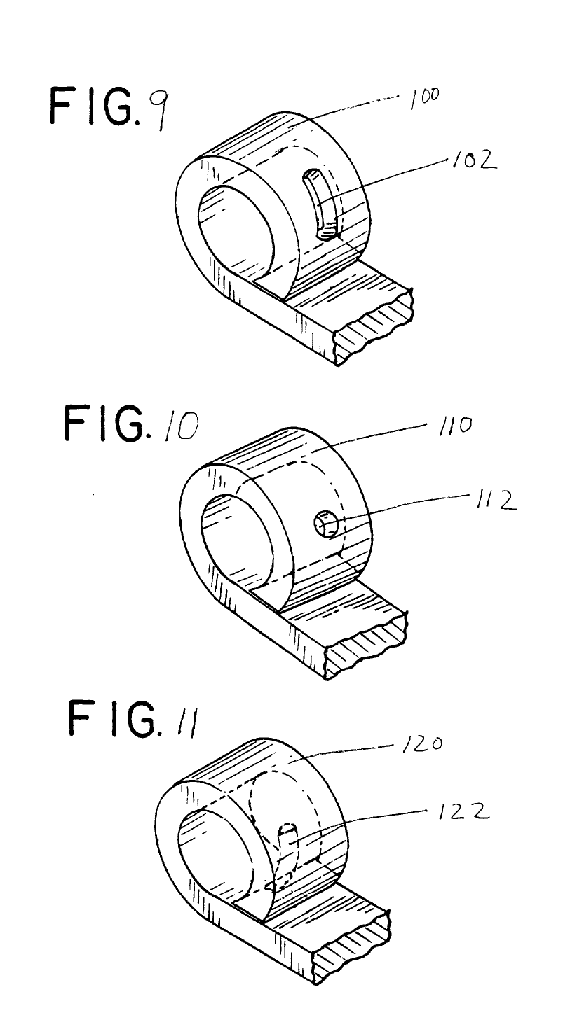

FIG. 4 illustrates the sleeveless bushing 44 installed within the leaf spring eye shown in FIG. 3. As illustrated, the ribbed portion 50 of sleeveless bushing 44 is positioned within and mated with the groove 42 of the leaf spring eye. In this arrangement, a relatively high centering and retention consistency can be achieved.

Referring back to FIG. 3, an already cured sleeveless bushing 44 is shown as being installed within the leaf spring eye. Installation is achieved by applying an axial force to one of the axial ends of either the sleeveless bushing 44, the leaf spring eye, or both.

It will be appreciated by those skilled in the art that alternatively the leaf spring eye and the metal sleeve 46 can be axially aligned within a mold assembly with the metal sleeve positioned within the inner diameter of the eye and the elastomeric portion 48 of sleeveless bushing 44 can be produced by a cast urethane. This alternative method of manufacture is within the province of the principles of the present invention.

FIG. 5 illustrates material 60 used to form a leaf spring. The portion of material 60 illustrated in FIG. 5 corresponds to that portion used to form the leaf spring eye of a conventional leaf spring. The inside surface defining the outer extent and boundary of the inner diameter for the leaf spring is illustrated as the top surface of material 60 in FIG. 5. In accordance with the principles of the present invention, a ribbed portion 62 is forged on the inside surface of the leaf spring eye and extends substantially along the entire circumference of the inner diameter for the leaf spring eye. Ribbed portion 62 is positioned at a location intermediate the axial ends of the leaf spring eye, which ends are defined by the side surfaces of material 60.

FIG. 6 illustrates the leaf spring eye formed by the portion of material 60 illustrated in FIG. 5. As shown, ribbed portion 62 extends substantially along the entire circumference of the inner diameter of the leaf spring eye. As further shown, ribbed portion 62 is positioned at a location intermediate the axial ends of the leaf spring eye.

FIG. 6 also illustrates a sleeveless bushing 64 constructed in accordance with the principles of the present invention. Sleeveless bushing 64 includes an elastomeric portion 66 having a bore 67 extending axially through it. A pin 68 is positioned in the bore 67 of elastomeric portion 66 in a manner well known in the art. Pin 68 includes a central rounded portion and two opposing flattened end portions having bores extending through them to permit connection with a frame hanger. This construction is well known in the art.

The elastomeric portion 66 of bushing 64 further includes a groove 70 extending circumferentially about it at a position located intermediate its axial ends, in accordance with the principles of the present invention.

FIG. 7 illustrates the sleeveless bushing 64 installed within the leaf spring eye shown in FIG. 6. As illustrated, the ribbed portion 62 of the leaf spring eye is positioned within and mated with the groove 70 of sleeveless bushing 64. In this arrangement, a relatively high centering and retention consistency can be achieved.

Referring back to FIG. 6, an already cured sleeveless bushing 64 is shown as being installed within the leaf spring eye. Installation is achieved by applying an axial force to one of the axial ends of either the sleeveless bushing 64, the leaf spring eye, or both.

It will be appreciated by those skilled in the art that alternatively pin 68 can be inserted into and positioned in axial alignment with the leaf spring eye within a mold assembly and the elastomeric portion 66 of sleeveless bushing 64 can be produced by a cast urethane. This alternative method of manufacture is within the province of the principles of the present invention.

It will be appreciated by those skilled in the art that the inner metal sleeve 46 shown in FIG. 3 can be incorporated for use within a sleeveless bushing having a groove, such as sleeveless bushing 64 shown in FIG. 6. In this arrangement, inner metal sleeve 46 is used in lieu of pin 68. Conversely, it will be appreciated by those skilled in the art that pin 68 can be used in lieu of inner metal sleeve 46 in the sleeveless bushing 44 having a ribbed portion 50 shown in FIG. 3.

FIG. 8 illustrates a pin 72 that can be alternatively surrounded by and adhered to an elastometic portion of a sleeveless bushing. Pin 72 includes a rounded central portion and two opposing rounded end portions. It will be appreciated by those skilled in the art that pin 72 can be incorporated for use in a sleeveless bushing with an elastomeric portion having a ribbed portion such as shown in FIG. 3, and can also be incorporated within a sleeveless bushing having an elastomeric portion with a groove as shown in FIG. 6.

FIG. 9 illustrates an alternative embodiment for a leaf spring eye 100 constructed in accordance with the principles of the present invention. As shown, leaf spring eye 100 includes a partial-circumference slot portion 102 extending through the entire thickness of the material used to construct the eye. Slot portion 102 does not extend substantially about the entire circumference of leaf spring eye 100. It will be understood that a bushing installed within the inner diameter of leaf spring eye 100 will include a protrusion designed to extend within and mate with slot portion 102.

FIG. 10 illustrates another alternative embodiment for a leaf spring eye 110 constructed in accordance with the principles of the present invention. Leaf spring eye 110 includes a circular hole portion 112 that does not extend substantially about the entire circumference of leaf spring eye 110. Hole portion 112 extends through the entire thickness of the material used to construct leaf spring eye 110. Again, the bushing is molded to include a protrusion that will extend within and mate with circular hole portion 112.

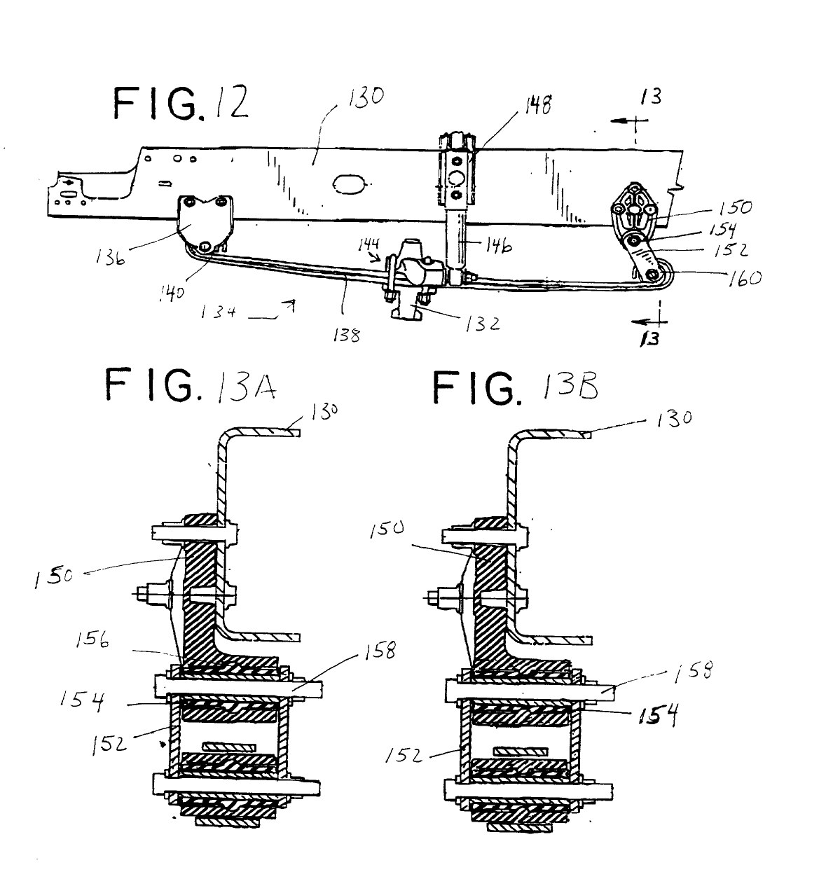

FIG. 11 illustrates another alternative embodiment of a leaf spring 120 constructed in accordance with the principles of the present invention. Leaf spring 120 includes a partial-circumference groove 122. In that regard, groove 122 does not extend substantially about the entire circumference of leaf spring eye 120. Rather, it extends about only a portion thereof. The bushing will be molded to include a protrusion that extends within groove 122 to mate therewith.

An advantage of using the leaf spring eyes illustrated in FIGS. 9-11 is that the tooling required to construct the leaf spring eye can be independent of the eye size. In particular, the distance from the scarf gap of the leaf spring to the slot, hole or groove can be constant over a range of eye sizes. This tooling standardization translates into reduced tooling costs, permitting enhanced product cycle time.

FIG. 12 illustrates conventional components included within vehicles, such as commercial vehicles, including a C-shaped longitudinally extending frame rail 130, a laterally extending axle 132, and suspension system components generally designated by reference numeral 134. A frame hanger 136 is attached to frame rail 130 to permit connection with a leaf spring assembly 138. Leaf spring assembly 138 includes a leaf spring eye 140 that receives a bushing (not shown) to permit connection with frame hanger 136. It will be appreciated that leaf spring eye 140 and the bushing installed therein are constructed in accordance with the principles of the present invention, and as described above.

Axle 132 and leaf spring assembly 138 are connected together by axle clamp assembly components generally designated 144. A shock absorber 146 is also included as a vehicle suspension component and is attached at its upper end to a bracket 148 mounted to frame rail 130. At its lower end, shock absorber 146 is seated on an axle seat portion of the suspension.

A shackle assembly including a shackle bracket 150 and pivoting shackle attachment 152 are included to permit connection of the opposite end of leaf spring assembly 138 to frame rail 130. In this arrangement, leaf spring assembly 138 is able to deflect during vehicle operation.

As shown, shackle bracket 150 is mounted to frame rail 130 and shackle attachment 152 is pivotally connected to shackle bracket 150. With reference to FIG. 13A, this pivotal attachment between shackle bracket 150 and pivoting shackle attachment 152 is carried out by use of a sleeveless bushing 154 having a ribbed portion 156 installed within a bushing receiving bore included within the shackle bracket. A pin 158 is then inserted through sleeveless bushing 154 to pivotally connect the pivoting shackle attachment 152 to the shackle bracket 150. A similar construction is used to attach the leaf spring eye 160 to the shackle attachment 152.

With reference to FIG. 13B, similar components are used. However, in this illustrated example, the sleeveless bushings have grooved portions, while the bushing receiving bores included within the shackle bracket 150 and shackle attachment 152 have ribbed portions to provide a mating attachment therewith. It will be appreciated by those skilled in the art that any combination of bushings and bushing receiving bores designed in accordance with the principles of the present invention can be used.

While the present invention has particular application to connecting a leaf spring eye to a frame hanger or shackle, FIGS. 12, 13A and 13B show that the principles of the present invention can be used in other vehicle suspension system applications, including connecting a shackle attachment to a shackle bracket. It will be appreciated by those skilled in the art that the principles of the present invention can be applied in a variety of suspension system applications wherein it is desired to connect two or more suspension system components by use of a bushing connection. The present invention is directed to a grooved or ribbed sleeveless bushing mated with a grooved or ribbed bushing receiving bore included within a suspension component.

In view of the foregoing, while this invention has been described with reference to particular illustrative forms, it will be understood that this description shall not be construed in a limiting sense. Rather, various changes and modifications can be made to the illustrative forms without departing from the true spirit and scope of the invention, as defined by the following claims. Furthermore, it will be appreciated that any such changes and modifications would be recognized by those skilled in the art as an equivalent to one element or more of the following claims, and shall be covered by such claims to the fullest extent permitted by law.

1. A suspension component connection assembly, comprising:
a suspension component having a bushing receiving bore with first and second opposing axial ends, said bushing receiving bore including a groove portion positioned intermediate said first and second axial ends of said suspension component; and
a sleeveless bushing having an elastomeric portion with first and second opposing axial ends, said elastomeric portion having a ribbed portion positioned intermediate said first and second axial ends of said elastomeric portion, said ribbed portion being adapted to fit within said groove portion of said suspension component.

2. The suspension component connection assembly of claim 1 wherein said suspension component comprises a leaf spring and said bushing receiving bore comprises a leaf spring eye.

3. The suspension component connection assembly of claim 1 wherein said suspension component comprises a shackle assembly.

4. The suspension component connection assembly of claim 1 wherein said sleeveless bushing further comprises a metal sleeve surrounded by said elastomeric portion.

5. The suspension component connection assembly of claim 1 wherein said sleeveless bushing further comprises a pin surrounded by said elastomeric portion.

6. The suspension component connection assembly of claim 1 wherein said bushing receiving bore has an inner diameter with a circumferential length and said groove portion of said suspension component extends substantially along the circumferential length of said inner diameter in its entirety.

7. The suspension component connection assembly of claim 1 wherein said bushing receiving bore has an inner diameter with a circumferential length and said groove portion of said suspension component extends along only a portion of said circumferential length of said inner diameter.

8. A suspension component connection assembly, comprising:
a suspension component having a bushing receiving bore with first and second opposing axial ends, said bushing receiving bore including a ribbed portion positioned intermediate said first and second axial ends of said suspension component; and
a sleeveless bushing having an elastomeric portion with first and second opposing axial ends, said elastomeric portion having a grooved portion positioned intermediate said first and second axial ends of said elastomeric portion, said ribbed portion being adapted to fit within said groove portion of said bushing.

9. The suspension component connection assembly of claim 8 wherein said suspension component comprises a leaf spring and said bushing receiving bore comprises a leaf spring eye.

10. The suspension component connection assembly of claim 8 wherein said suspension component comprises a shackle assembly.

11. The suspension component connection assembly of claim 8 wherein said sleeveless bushing further comprises a metal sleeve surrounded by said elastomeric portion.

12. The suspension component connection assembly of claim 8 wherein said sleeveless bushing further comprises a pin surrounded by said elastomeric portion.

13. The suspension component connection assembly of claim 8 wherein said bushing receiving bore has an inner diameter with a circumferential length and said ribbed portion of said suspension component extends substantially along the circumferential length of said inner diameter in its entirety.

14. A suspension component connection assembly, comprising:
a suspension component having a bushing receiving bore with first and second opposing axial ends, said bushing receiving bore including a slot portion positioned intermediate said first and second axial ends of said suspension component; and
a sleeveless bushing having an elastomeric portion with first and second opposing axial ends, said elastomeric portion having a protrusion positioned intermediate said first and second axial ends of said elastomeric portion, said protrusion being adapted to fit within said slot of said suspension component.

15. The suspension component connection assembly of claim 14 wherein said suspension component comprises a leaf spring and said bushing receiving bore comprises a leaf spring eye.

16. The suspension component connection assembly of claim 14 wherein said sleeveless bushing further comprises a metal sleeve surrounded by said elastomeric portion.

17. The suspension component connection assembly of claim 14 wherein said sleeveless bushing further comprises a pin surrounded by said elastomeric portion.

18. A suspension component connection assembly, comprising:
a suspension component having a bushing receiving bore with first and second opposing axial ends, said bushing receiving bore including a hole positioned intermediate said first and second axial ends of said suspension component; and
a sleeveless bushing having an elastomeric portion with first and second opposing axial ends, said elastomeric portion having a protrusion positioned intermediate said first and second axial ends of said elastomeric portion, said protrusion being adapted to fit within said hole of said suspension component.

19. The suspension component connection assembly of claim 18 wherein said suspension component comprises a leaf spring and said bushing receiving bore comprises a leaf spring eye.

20. The suspension component connection assembly of claim 18 wherein said sleeveless bushing further comprises a metal sleeve surrounded by said elastomeric portion.

21. The suspension component connection assembly of claim 18 wherein said sleeveless bushing further comprises a pin surrounded by said elastomeric portion.
